(19) United States
(12) Patent Application Publication
(10) Pub. No.: US 2023/0141066 A1
(43) Pub. Date: May 11, 2023

(54) DENTAL IMPLANT TO BE PLACED IN THE POSTERIOR UPPER JAW

(71) Applicant: NODRILL S.R.L., Pescara (IT)

(72) Inventor: Paolo Trisi, Pescara (IT)

(21) Appl. No.: 17/919,741

(22) PCT Filed: Apr. 19, 2021
(86) PCT No.: PCT/IB2021/053191

§ 371 Date: Oct. 18, 2022

(30) Foreign Application Priority Data
Apr. 20, 2020 (IT) 102020000008326

(51) Int. Cl. A61C 8/00

(52) U.S. Cl. CPC A61C 8/0024; A61C 8/0037

(57) ABSTRACT

A dental implant implantable in the upper rear maxilla following the lifting of the sinus membrane of the maxillary sinus by the crestal approach has a body with a shank shape. The body includes a main portion and, on opposite sides thereof, a first crestal proximal portion and a second apical distal part. The body is provided with a threading having a spiral shape with cutting edges. The threading extends in spiral fashion only about and along the main portion of the body and terminates before the second apical distal part, while the second apical distal part is conformed to provide an external surface free of projecting or cutting parts, and is at lest partially provided annularly with a groove or a series of grooves.

### FIELD OF THE INVENTION

The present invention relates to the technical sector relating to implantology, i.e. the technique with which it is possible to restore, by application of a dental implant (or endosseus implant), a fixed dentition in those who, for various motives or reasons, have suffered the loss of one or more of their natural teeth.

In particular, the present invention relates to a dental implant which, owing to its special conformation, is specifically designed to be implanted in the upper rear maxilla bone, following a lifting of the maxillary sinus with the crestal approach.

### DESCRIPTION OF THE PRIOR ART

The area of the upper rear maxilla is one of the most delicate and difficult-to-treat areas for application of dental implants.

By its nature, the upper rear maxilla bone has a slim thickness, if compare for example with the mandibular bone (lower maxilla bone).

Further, as a consequence of a loss of a tooth (for example a premolar or molar) in a rear area of the upper maxilla bone, the thickness of the upper maxilla bone tends to be further reduced due to the bone atrophy consequent to resorption of the alveolar crest.

The reduction of the thickness of the upper rear maxilla bone leads, as a consequence, to an increase in the volume of the maxillary sinus with a lowering of the sinus membrane (or Schneiderian membrane), i.e. the mucose membrane which internally clads the paranasal cavity of the maxillary sinus.

This reduction of the upper rear maxilla bone leads, as a consequence, to the impossibility of directly implanting a dental implant for the support of a prosthetic replacement (artificial tooth) and thus being able to replenish the patient's set of teeth.

For example, the reduction of the upper rear maxilla bone can result in the bone having an extremely small thickness, between about 2-3 mm and about 6-7 mm.

In these cases, where the vertical thickness of the upper rear maxilla bone has undergone a reduction in thickness such as to prevent direct application of a dental implant, implantological methods include carrying out a lifting of the maxillary sinus, i.e. a raising of the sinus membrane, with the insertion of bone implant material, so as to regenerate a bone thickness that is sufficient to enable a subsequent application of a dental implant.

A first known method, illustrated in FIG. 1A, so as to carry out a lifting of the maxillary sinus (SM) with a bone implant, includes carrying out an opening (AL) for lateral access by means of lateral antrostomy, i.e. the opening of a bone window in the lateral wall (vestibular) (PL) of the maxillary sinus (SM).

Once the lateral opening (AL) has been made, a certain amount of bone implant material (I) can be inserted, with a consequent lifting of the maxillary sinus (SM) and therefore a lifting of the sinus membrane (M), which operation will enable increasing the vertical thickness of the upper rear maxilla bone (O).

Once the bone implant (I) has been inserted, it is possible to proceed with the insertion of a dental implant (D).

This type of method has, however, considerable drawbacks, for example complications can arise that might be serious, such as an infection of the implant with consequent sinusitis or pansinusitis, oedema and post-operative pain for the patients.

Further, the transformation times (remodelling) for the implant and osteointegration of inserted dental implants that are rather long, even up to 12 months following the operation, and therefore a considerable passage of time is necessary before application of the prosthetic element, i.e. the artificial tooth.

A further known method is illustrated in FIG. 1B.

This method includes carrying out an increase in the thickness of the upper rear maxilla bone (O) in a vertical direction, with a lifting of the maxillary sinus (SM) by the crestal approach.

This method is less invasive with respect to the method that includes the lateral approach, as the carrying out of an opening of a lateral window of the maxillary sinus is not required, thus reducing the risks and the post-operative complications. It includes, once the gum (G) has been opened, carrying out the perforation of the upper rear maxilla bone (O) and the bone floor (PO) of the maxillary sinus (SM) using special instruments (for example burrs or scalpels) without perforating or damaging the sinus membrane (M), which clads the bone floor (PO) of the maxillary sinus (SM).

Therefore it is possible to proceed using other suitable instruments (of a manual or mechanical type) with the detaching and lifting of the maxillary sinus (SM) from the bone floor (PO) of the sinus membrane (M), without perforating it, and therefore with a subsequent insertion of particulate bone implant material (I) inside the hole (F) made, up to beneath the lifted sinus membrane (M), in order to increase the bone thickness in which to insert and apply the dental implant (D).

The known dental implants (D), used for implantation into the upper rear maxilla bone, following the lifting of the maxillary sinus by crestal approach with the method now described, all have substantially the shape illustrated in FIGS. 1C and 1D.

These dental implants (D) comprise a body (C) having a shank shape, for example a truncoconical or cylindrical shape, having a main part (CP) and, on opposite sides to the main part (CP), a first proximal portion (C1), or crestal, and a second distal part (C2), or apical.

In the proximal part (C1) (crestal) there is a housing (S) for inserting and positioning the prosthetic element (artificial tooth) (not illustrated).

The shank-shaped body (C) also comprises a threading (FA) which extends with a spiral shape, about the body (C), starting from the proximal part (C1) (crestal) and which, crossing the main part (CP), reaches the distal part (C2) (apical).

In order to be able to guarantee an optimal mechanical seal and notwithstanding the upper rear maxilla bone (O), this threading (FA) can have a slim thickness, and must be especially sharp, with very pronounced cutting edges.

This dental implant (D) must be inserted, by the distal part (apical) (C2) thereof, in the hole (F) made by crestal approach in the upper rear maxilla bone (O), and then can be screwed in, in such a way that the cutting edges of the spiral threading (FA) penetrate and grip in the bone (O), in order to guarantee mechanical stability, until it is completely inserted in the hole (F) so that the proximal part (crestal) (C1) is at the opening of the hole (F) on the gum (G) (see FIG. 1B).

During the screwing-in, the distal part (C2) (apical) of the dental implant (D) crosses the zone in which the bone implant (I) has been inserted and can reach into contact with the sinus membrane (M) (see FIG. 1B once more).

This step of insertion of the dental implant (D) is very delicate, as the sharp threading (FA) present in the apical distal part (C2) of the dental implant (D), reaching into contact with the sinus membrane (M), might perforate it, jeopardising the success of the surgical operation.

If this event were to occur, the material used for the bone implant (I) might penetrate into the cavity of the maxillary sinus (SM), with the serious danger and risk of onset of very significant infections, sinusitis or pansinusitis.

Further, during the screwing-in of the dental implant (D) into the hole (F), the spiral fashion threading (FA) with the cutting edges, present in the upper portion (CP1) of the main part (CP) of the body (C) of the dental implant (D) which lies beneath the apical distal part (C2), penetrates into the material of the bone implant (I) previously inserted in the hole (F).

The presence of a sharp threading (FA) with cutting edges in the upper portion (CP1) of the main part (CP) of the body (C) which penetrates, during the screwing-in of the dental implant (D), into the bone implant material (I) can lead to a dislocation of this material, a circumstance that can lead, as a consequence, to an incorrect osteointegration of the dental implant.

The aim of the present invention is therefore to provide a new dental implant to be implanted into the upper rear maxilla bone following the lifting of the sinus membrane (M) of the maxillary sinus (SM) by the crestal approach, able to obviate the drawbacks present in the prior-art dental implants described in the foregoing.

### SUMMARY OF THE INVENTION

In particular, an aim of the present invention is to provide a novel dental implant having a shape such as to be inserted and screwed into a hole, made by crestal approach in a point of the upper rear maxilla bone with a lifting of the sinus membrane and the insertion of a bone implant material, and to guarantee an excellent mechanical grip, at the part of the residual maxilla bone, and at the same time prevent any damage to the sinus membrane of the maxillary sinus as well as any dislocation of the bone implant material.

The above aims are attained according to the claims.

### BRIEF DESCRIPTION OF THE DRAWINGS

The features of preferred, but not exclusive, embodiments of the dental implant of the present invention will be described in the following with reference to the appended tables of drawings, in which:

FIG. 1A, already mentioned in the foregoing, schematically illustrates the implantological technique of a dental implant of the prior art following the making of an opening of a lateral window in the upper rear maxilla bone;

FIG. 1B, already mentioned in the foregoing, schematically illustrates a dental implant of the prior art implanted in the upper rear maxilla bone following the lifting, with the crestal approach, of the sinus membrane of the maxillary sinus and the insertion of a bone implant;

FIGS. 1C and 1D illustrate, in relative schematic perspective views, two dental implants of the prior art which are implanted in the upper rear maxilla bone following the lifting of the maxillary sinus with the crestal approach;

FIGS. 2A, 2B, 2C and 2D illustrate preferred embodiments of the dental implant of the present invention;

FIG. 3A is a larger-scale view of the detail denoted by letter K of FIG. 2A;

FIG. 3B illustrates the detail denoted by H of FIG. 2B in larger scale;

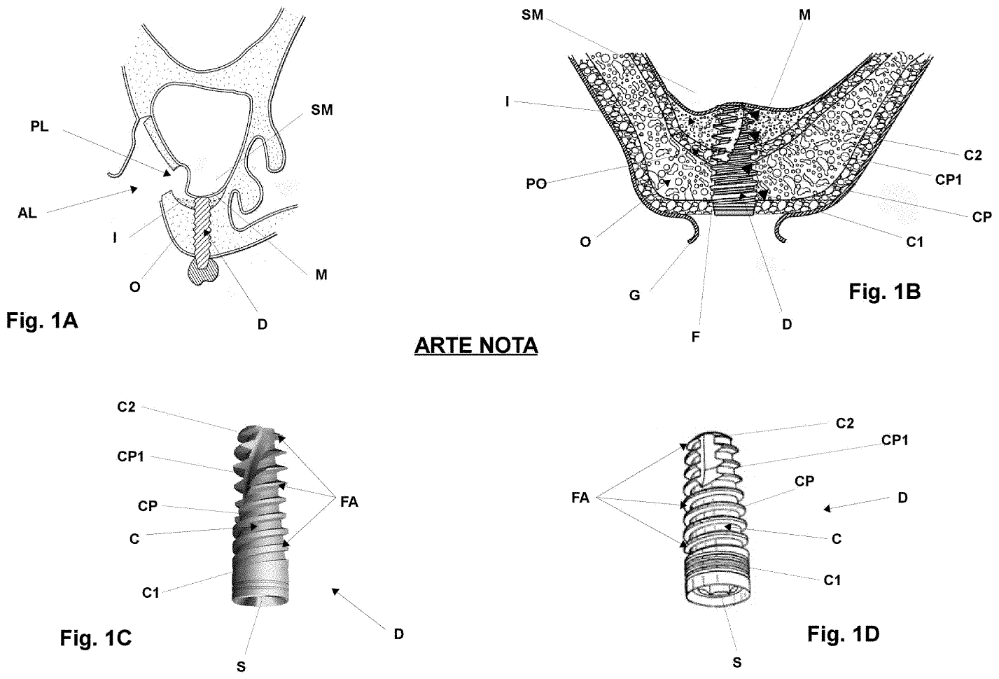

Figures from 4A to 4F schematically illustrate a possible operating sequence for the lifting of the sinus membrane with the crestal approach, with the insertion of a bone implant material, and the subsequent application of a dental implant according to the present invention.

### DESCRIPTION OF THE PREFERRED EMBODIMENTS

With reference to the accompanying tables of drawings, reference numeral (100) denotes the dental implant of the present invention, in its entirety and in the preferred but not exclusive embodiments thereof.

The dental implant (100) is specially conformed to be specifically destined for implantation in the upper rear maxilla bone (O) when the relative thickness is too small to proceed to a direct application of a dental implant, and a preparatory lifting of the sinus membrane (M) of the maxillary sinus (SM) by the crestal approach is required, with the insertion of a bone implant material (I).

The dental implant (100) of the invention comprises a body (1), which has a shank shape, and which comprises a main portion (10) and, on opposite sides with respect to the main portion (10), a first crestal proximal portion, (11), and a second apical distal part, (12).

The dental implant (100) further comprises a threading (2) having a spiral shape with cutting edges (21).

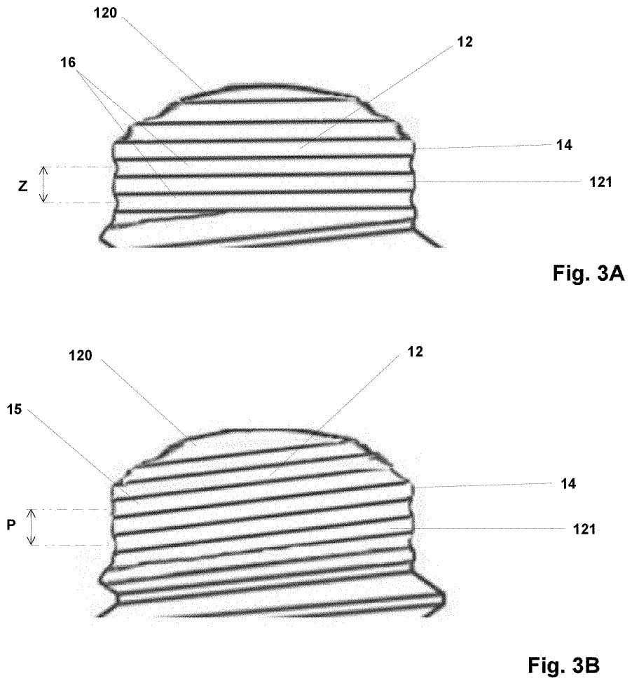

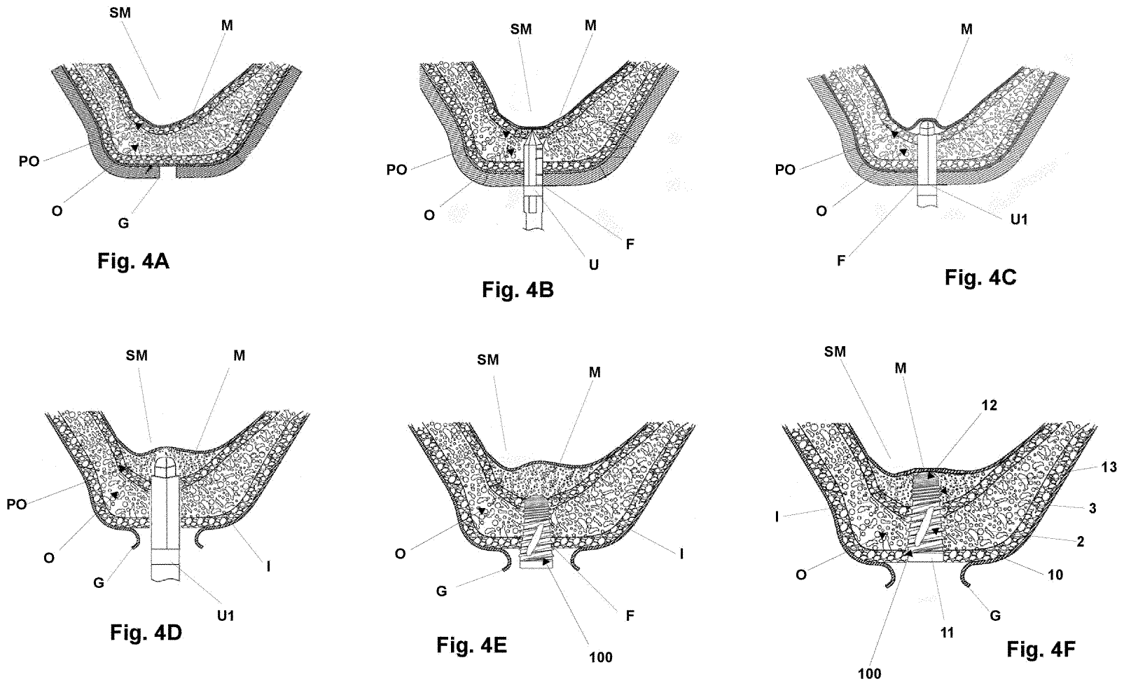

The special characteristics of the dental implant (100) of the present invention consist in the fact that (see figures from 2A to 2D, and FIGS. 3A and 3B):

the threading (2) having a spiral shape with cutting edges (21) extends in spiral fashion only about and along the main portion (10) of the body (1) terminating before the second apical distal part (12);

the second apical distal part (12) is conformed in such a way as to comprise an external surface (14) free of projecting or cutting parts, and so that the external surface (14), at least partially, annularly has a groove (15) or a series of grooves (16).

In substance, then, the threading (2) having a spiral shape winds only about the main portion (10) of the body (1), while the second apical distal part, (12) has an external surface (14), substantially smooth, without projections, protuberances or projecting cutting profiles, but which has only a groove or series of grooves, i.e. furrows or recesses, in any case free of sharp or cutting edges.

Owing to these special characteristics, the dental implant (100) of the invention obviates the drawbacks present in dental implants of known type and enables obtaining the following advantages, as identified in figures from 4A to 4F.

These figures illustrate an operating sequence for implanting the dental implant (100) of the invention in a hole (F) made by crestal approach in a point of the upper rear maxilla bone (O) in which an artificial tooth is to be positioned following the loss of a natural tooth (premolar, or molar) with a consequent reduction of the vertical thickness of the maxilla bone.

FIGS. 4A and 4B illustrate the step of making of a hole (F), with the crestal approach, in the upper rear maxilla bone (O) following the opening of the gum (G). To follow up such a hole (F) by the crestal approach, a special instrument (U) is used (of known type, of the burr or scalpel type) to perforate the upper maxilla bone (O) up to reaching the bone floor (PO) of the maxillary sinus (SM) without perforating the sinus membrane (M).

Using a special instrument (U1) (of known type, mechanical or manual), which is inserted in the previously-bored hole (F), it is possible to proceed to the lifting of the sinus membrane (M), creating a volume for insertion of bone implant material (I), thus completing the lifting of the maxillary sinus (SM) and increasing the total thickness of bone support (natural bone plus bone implant material) in which to implant the dental implant (100) (see FIGS. 4C and 4D).

At this point, it is possible to insert the second apical distal part (12) of the dental implant (100) of the invention into the hole (F) (FIG. 4E) and screw the dental implant (100) into the hole in such a way that the cutting edges (21) of the threading (2) present along the main portion (10) of the body (1) gain a grip, by penetrating into the upper rear maxilla bone (O), causing the whole dental implant (100) to insert into the hole (F), positioning it with the first crestal proximal portion (11) at the external end of the hole (F), at the position in which the gum (G) will be repaired and in which the prosthetic element (artificial tooth) will be applied in a special seat (not illustrated as of known type) present in the a first crestal proximal portion (11) (FIG. 4F).

As can be seen in FIG. 4F, the second apical distal part (12) is positioned at the position of the bone implant material (I) and, possibly, even in contact with the sinus membrane (M).

During the step of screwing-in the dental implant (100) into the hole (F), the second apical distal part (12), not having any projection or cutting part in the relative lateral surface (14), even if it were to reach into contact with the sinus membrane (12), would not cause any lesion or tearing of the sinus membrane (M). In other words, during the screwing-in and complete insertion of the dental implant (100) of the invention in the hole (F), the sinus membrane (M) may be reached and contacted by the second apical distal end of the implant but as there is no projecting or cutting part on the external surface (14) of the second apical distal end, the sinus membrane (M) will be protected against any tearing or abrasion.

In substance, the second apical distal end (12) of the dental implant (100) of the present invention is, due to its special conformation, completely atraumatic, enabling conservation of the integrity of the sinus membrane (M) even should, following the complete insertion of the dental implant (100) in the hole (F) made in the upper rear maxilla bone (O), the second apical distal end (12) reach into contact with the sinus membrane (M).

Further, as is once more clearly visible from FIG. 4F, the second apical distal part (12) of the dental implant (100) will be positioned at the bone implant material (I), previously inserted in the hole (F) following the lifting of the maxillary sinus (SM), i.e. the sinus membrane (M).

Owing to the absence of projecting or cutting parts in the external surface (14) of the second apical distal part (12), the screwing-in of the second apical distal part (12) into the bone implant material (I) will not lead to any dislocation of the material.

Further, the presence of one or more grooves in the external surface (14) of the second apical distal part (12) will facilitate a greater adhesion of the bone implant material (I) to the dental implant (100), facilitating a more effective and rapid osteointegration.

Lastly, the threading (2) with cutting edges (21), which extends only along the main portion (10) of the body (1) of the dental implant (100), will substantially be positioned at the maxilla bone (O), i.e. at the residual natural and original portion of bone, facilitating an excellent adhesion and mechanical fixing of the dental implant.

It is clear, therefore, from the above description, and from what is illustrated in the figures, in particular in FIGS. 4R and 4F, how the dental implant (100) of the present invention obviates, in an extremely effective way, the drawbacks present in the dental implants of the prior art, and advantageously obviates the drawbacks and complications cause by the use thereof.

Other further advantageous characteristics and preferred aspects of the dental implant (100) of the invention are described in the following; these characteristics can exist singly or in any combination with one another.

In the appended figures, some preferred combinations are illustrated, though the dental implant of the present invention can in any case have other combinations or further accessory characteristics, all falling within the scope of the present invention, as set out in claim 1.

The dental implant (100) can preferably be realised in such a way as to have an overall length (H) comprised between 6 and 20 mm, with the main part (10) of the body (1) having a length (H1) for example comprised between 3 and 13 mm, and with the second apical distal part (12) having a length (H2) for example for example comprised between 0.5 and 10 mm.

The second apical distal part (12) is preferably conformed in such a way as to comprise an end portion (120) having a spherical cap shape.

The second apical distal part (12) can be conformed in such a way as to comprise an cylindrically-shaped portion (121) and an end portion (120) having a spherical cap shape. For example a cylindrically-shaped portion (121) having a height comprised between 0 and 10 mm and an end portion (120) having a spherical cap shape having a height comprised between 0.5 and 3 mm.

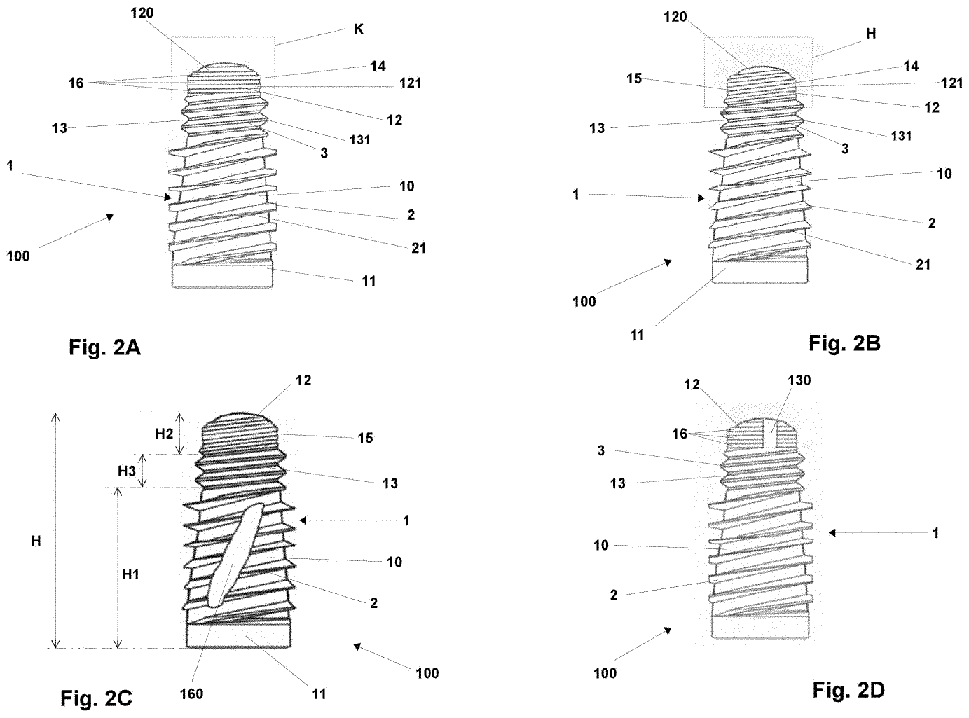

According to preferred embodiments, for example illustrated in FIGS. 2B, 2C, 3B, the second apical distal part, (12) is conformed so that the relative external surface (14) annularly has a groove (15) which extends with a spiral shape along the external surface (14).

For example, the spiral-shaped groove (15) extends at least along the cylindrically-shaped portion (121).

The spiral-shaped groove (15) preferably forms a spiral having a constant or variable pitch (p); for example it can have a constant pitch (p) comprised between 0.1 mm and 1.5 mm.

The spiral-shaped groove (15) can preferably have a depth comprised between 0.01 mm and 1.5 mm.

In other preferred embodiments, for example illustrated in FIGS. 2A, 2D and 3A, the second apical distal part (12) is conformed in such a way that the relative external surface (14) annularly has a series of grooves (16) having a circular or semi-circular shape, being coaxial and reciprocally arranged superposed and distanced by a constant or variable distance (z); for example with a constant distance (z) comprised between 0.01 mm and 1.5 mm.

For example, the apical distal part, (12) is conformed in such a way that the series of grooves (16) having a circular or semi-circular shape are arranged at least along the cylindrically-shaped portion (121).

The grooves (16) can preferably have a depth comprised between 0.01 mm and 1.5 mm.

The grooves (16) can all be circumferentially formed, all being semi-circumferential, or having an arc of circumference shape, or some of which being circumferentially formed and others having a semi-circumferential or an arc of circumference shape.

The second apical distal part, (12) can possibly be conformed in such a way that the relative external surface (14) can be affected by a plurality of grooves having a spiral shape intervalled from one another along the height of the second apical distal part (12) or an alternation between grooves having a circumferential shape, a semi-circumferential or an arc of circumference shape, and grooves having a spiral shape, or even grooves of another other shape or progression, as long as they are free of projecting or cutting edges.

According to the special preferred but not exclusive embodiments illustrated in the figures of the drawings, the dental implant (100) can be realised in such a way that the body (1) further comprises an intermediate portion (13), which is arranged between the main portion (10) and the apical distal part (12).

In these cases, the dental implant (100), further comprises a second threading (3) which winds in a spiral fashion only about the intermediate portion (13), the second threading (3) being conformed in such a way as to have rounded and not cutting edges (131).

The intermediate portion (13), once the dental implant (100) has been completely inserted in the hole (F) made in the upper rear maxilla bone (C) by the crestal approach, may be positioned at the bone implant material (I) (see FIG. 4F).

Owing to the presence of the second threading (3) on the intermediate part (13), the screwing-in and insertion of the dental implant (100) will be facilitated, as will the fixing thereof to the bone implant material (I).

At the same time, the presence of rounded and non-cutting edges (131) on the second threading (3) in the intermediate part (13), will prevent, or at least reduce, any possible dislocation of the bone implant material during the screwing-in of the dental implant (100).

It is newly specified, as previously, that the presence of the intermediate portion (13) is not an essential aspect, as the dental implant (100) of the invention can be made without the intermediate portion (13), i.e. with only the main portion (10) and the second apical distal part (12) at an end of the main portion (10).

The presence of the intermediate portion (13), between the main portion (10) and the second apical distal part (12) might enable obtaining further preferred advantages, as illustrated in the foregoing.

The main portion (10) of the body (1) is preferably conformed so as to have a truncoconical shape, for example with a first smaller diameter comprised between 3 and 7 mm, and with a second bigger diameter comprised between 0.3 and 2 mm, or have a cylindrical shape, for example with a diameter comprised between 3 and 7 mm.

In a case where the intermediate portion (13) is present, it can be conformed so as to have a cylindrical or truncoconical shape, for example with a height comprised between 0 and 10 mm, and a diameter comprised between a minimum value of about 1.7 mm and a maximum value of about 7 mm.

The apical distal part (12) is preferably realised in such a way as to comprise a longitudinal recess (130), performing a function of material discharge during the screwing-in of the dental implant (100) (visible for example in FIG. 2D).

The main part (10) of the body (1) is preferably realised in such a way as to comprise a furrow (160), also having the function of a discharge, arranged substantially longitudinally to the main part (10) and transversally to a part of the threads of the threading (2) having a spiral shape (see FIG. 2C).

1. A dental implant to be implanted in the upper rear maxillary following the lifting of the sinus membrane of the maxillary sinus by the crestal approach, comprising:
a body having a shank shape, comprising a main portion and, on opposite sides with respect to the main portion, a first crestal proximal portion, and a second apical distal part; and
a threading having a spiral shape with cutting edges,
the threading having a spiral shape with cutting edges extends in spiral fashion only about and along the main portion of the body terminating before the second apical distal part;
the second apical distal part having an external surface free of projecting or cutting parts, the external surface at least partially provided with a groove or a series of grooves.

2. The dental implant of claim 1, wherein the second apical distal part includes an end portion with a spherical cap shape.

3. The dental implant of claim 1, wherein the second apical distal part includes a cylindrically-shaped portion and an end portion having a spherical cap shape.

4. The dental implant of claim 1, wherein the external surface of the second apical distal part is formed with a groove which extends with a spiral shape along the external surface.

5. The dental implant of claim 4, wherein the second apical distal part includes a cylindrically-shaped portion and an end portion having a spherical cap shape, the groove extending at least along the cylindrically-shaped portion.

6. The dental implant of claim 4, wherein the groove forms a spiral having a constant or variable pitch.

7. The dental implant of claim 1, wherein the external surface of the second apical distal part is formed with a series of grooves having a circular or semi-circular shape, being coaxial and reciprocally arranged and superposed and distanced by a constant or variable distance.

8. The dental implant of claim 7, wherein the grooves having a circular or semi-circular shape are arranged at least along a cylindrically-shaped portion of the second apical distal part.

9. The dental implant of claim 1, wherein the body comprises an intermediate portion arranged between the main portion and the second apical distal part, further comprising a second threading which winds in a spiral fashion only about the intermediate portion, the second threading having rounded and not cutting edges.

10. The dental implant of claim 1, wherein the main portion of the body has a truncoconical shape or a cylindrical shape.

11. The dental implant of claim 9, wherein the main portion of the body has a truncoconical shape or a cylindrical shape and wherein the intermediate portion of the body has a cylindrical or truncoconical shape.

12. The dental implant of claim 1, wherein the second apical distal part has a longitudinal recess.

13. The dental implant of claim 1, wherein the main part of the body has a furrow arranged substantially longitudinally to the main part and transversally to a part of the threads of the threading having a spiral shape.
